(19) United States
(12) Patent Application Publication
(10) Pub. No.: US 2014/0180699 A1
(43) Pub. Date: Jun. 26, 2014

(54) ADVANCED RISK STRATIFICATION FOR CLINICAL DECISION SUPPORT

(71) Applicant: CERNER INNOVATION, INC., Lenexa, KS (US)

(72) Inventors: SHARON MASSA, Kansas City, MO (US); BENJAMIN DAVID WILKERSON, Lee's Summit, MO (US); HUGH H. RYAN, Lee's Summit, MO (US); DONNA J. CAPPO, Independence, MO (US)

(73) Assignee: CERNER INNOVATION, INC., Lenexa, KS (US)

(21) Appl. No.: 13/727,061

(22) Filed: Dec. 26, 2012

(51) Int. Cl. G06F 19/00

(52) U.S. Cl. CPC G06F 19/3431
USPC 705/2

(57) ABSTRACT

Systems, methods, and user interfaces for providing dynamic risk stratification for clinical decision support are provided. Selections of patient types are received for patients. Assessments to utilize are determined in accordance with the patient types. The assessments are displayed to facilitate first clinicians assessing risk factors and contraindications for the patients. Information associated with the patients is received. Second clinicians may be alerted if risk factors for the patients are identified and the assessments have not been completed. Pharmacologic and/or mechanical prophylaxis is recommended and overall risk levels associated with the patients are indicated.

### BACKGROUND

In the area of computer assisted clinical decision support, risk stratification systems are necessary for grading risk of a patient in regard to certain conditions. Present systems utilize a single risk stratification system that is applied to all types of patients for a certain condition. Because these systems use a single risk stratification designed for the general population rather than for a particular patient, inaccurate and imprecise risk assignment often results. This contributes to decreased quality of care, increased risk of medical errors, and increased cost of healthcare.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to systems, methods, and user interfaces for providing advanced risk stratification for clinical decision support. Embodiments of the present invention enable clinicians to apply the most appropriate risk stratification system for a particular patient within a single condition management program.

Accordingly, in one aspect, computer storage media having computer-executable instructions embodied thereon that, when executed by one or more computing devices, causes the one or more computing devices to perform a method of providing dynamic risk stratification. A selection of a patient type for a patient is received. An assessment to utilize in accordance with the patient type is determined. The assessment is displayed to facilitate a first clinician assessing risk factors and contraindications for the patient. Information associated with the patient is received. Pharmacologic prophylaxis, mechanical prophylaxis, or a combination thereof is recommended. An overall risk level associated with the patient is indicated.

In another embodiment, a computer system for providing dynamic risk stratification for clinical decision support is provided. The system comprises a processor coupled to a computer storage medium, the computer storage medium having stored thereon a plurality of computer software components executable by the processor. A patient type component receives a selection of a patient type for a patient. An assessment component determines an assessment to utilize in accordance with the patient type. A display component displays the assessment to facilitate a clinician assessing risk factors and contraindications for the patient. A receiving component receives information associated with the patient. A recommendation component recommends pharmacologic prophylaxis, mechanical prophylaxis, or a combination thereof. A risk component indicates an overall risk level associated with the patient. A transfer component includes the assessment in transfer order sets to facilitate reevaluation of the risk stratification for the patient.

In another embodiment, computer storage media having computer-executable instructions embodied thereon that, when executed, produce a graphical user interface (GUI) to facilitate providing dynamic risk stratification for clinical decision support. A patient type display area is configured to display a selectable list of patient types for a patient. An assessment display area is configured to display an assessment to a clinician in accordance with the patient type. An information display area is configured to display information associated with the patient. An alert display area is configured to alert the clinician if risk factors for the patient are identified and the assessment has not been completed. A recommendation display area is configured to display recommendations for pharmacologic prophylaxis, mechanical prophylaxis, or a combination thereof. A risk display area is configured to display an overall risk level associated with the patient.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing environment suitable for use in implementing the present invention;

FIG. 2 is a block diagram of an exemplary system for providing dynamic risk stratification for clinical decision support in accordance with an embodiment of the present invention;

FIG. 3 is a flow diagram showing an exemplary method for providing dynamic risk stratification for clinical decision support in accordance with various embodiments of the present invention; and

FIGS. 4-7 are illustrative screen displays in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Embodiments of the present invention can positively impact health organizations' key imperatives in a variety of ways. Embodiments of the present invention utilize multiple risk stratification systems based on input associated with a particular patient in order to provide the greatest accuracy of risk stratification for the particular patient. Embodiments of the present invention allows the most appropriate risk stratification system for the particular patient resulting in more accurate and appropriate treatment, greater quality of care, and increased safety.

Having briefly described embodiments of the present invention, an exemplary operating environment suitable for use in implementing embodiments of the present invention is described below.

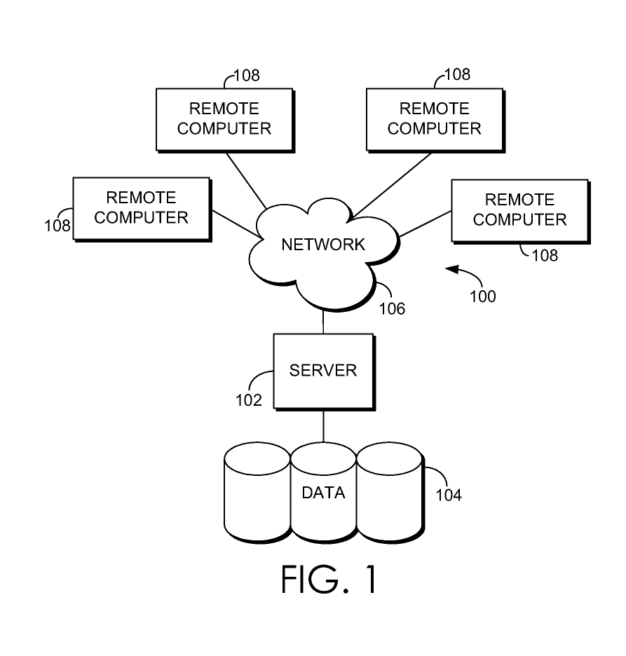

Referring now to the drawings in general, and initially to FIG. 1 in particular, an exemplary computing system environment, for instance, a medical information computing system, on which embodiments of the present invention may be implemented is illustrated and designated generally as reference numeral 100. It will be understood and appreciated by those of ordinary skill in the art that the illustrated medical information computing system environment 100 is merely an example of one suitable computing environment and is not intended to suggest any limitation as to the scope of use or functionality of the invention. Neither should the medical information computing system environment 100 be interpreted as having any dependency or requirement relating to any single component or combination of components illustrated therein.

Embodiments of the present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

Embodiments of the present invention may be described in the general context of computer-executable instructions, such as program modules, being executed by a computer. Generally, program modules include, but are not limited to, routines, programs, objects, components, and data structures that perform particular tasks or implement particular abstract data types. Embodiments of the present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 100 includes a general purpose computing device in the form of a server 102. Components of the server 102 may include, without limitation, a processing unit, internal system memory, and a suitable system bus for coupling various system components, including database cluster 104, with the server 102. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 102 typically includes, or has access to, a variety of computer readable media, for instance, database cluster 104. Computer readable media can be any available media that may be accessed by server 102, and includes volatile and nonvolatile media, as well as removable and non-removable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 102. In one embodiment, computer storage media excludes signals per se. In this regard, in one embodiment, computer storage media is non-transitory. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 104, provide storage of computer readable instructions, data structures, program modules, and other data for the server 102. In embodiments, database cluster 104 takes the form of a cloud-based data store. In embodiments, the cloud-based data store is accessible by a cloud-based computing platform.

The server 102 may operate in a computer network 106 using logical connections to one or more remote computers 108. Remote computers 108 may be located at a variety of locations in a medical or research environment, for example, but not limited to, clinical laboratories, hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 108 may also be physically located in non-traditional medical care environments so that the entire health care community may be capable of integration on the network. The remote computers 108 may be personal computers, servers, routers, network PCs, peer devices, other common network nodes, or the like, and may include some or all of the components described above in relation to the server 102. The devices can be personal digital assistants or other like devices. In embodiments, remote computers 108 comprise computing-devices that are part of a cloud-computing platform. In embodiments, a remote computer 108 is associated with a health records, data source such as an electronic health record (EHR) system of a hospital or medical organization, a health information exchange EHR, insurance provider EHR, ambulatory clinic EHR, or patient-sensor, or other data source, and facilitates accessing data of the source and communicating the data to server 102 and/or other computing devices on a cloud computing platform, including other remote computers 108.

Exemplary computer networks 106 may include, without limitation, local area networks (LANs) and/or wide area networks (WANs). Such networking environments are commonplace in offices, enterprise-wide computer networks, intranets, and the Internet. When utilized in a WAN networking environment, the server 102 may include a modem or other means for establishing communications over the WAN, such as the Internet. In a networked environment, program modules or portions thereof may be stored in the server 102, in the database cluster 24, or on any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., server 102 and remote computers 108) may be utilized.

In operation, a user may enter commands and information into the server 102 or convey the commands and information to the server 102 via one or more of the remote computers 108 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 102. In addition to a monitor, the server 102 and/or remote computers 108 may include other peripheral output devices, such as speakers and a printer.

Although many other internal components of the server 102 and the remote computers 108 are not shown, those of ordinary skill in the art will appreciate that such components and their interconnections are well known. Accordingly, additional details concerning the internal construction of the server 102 and the remote computers 108 are not further disclosed herein.

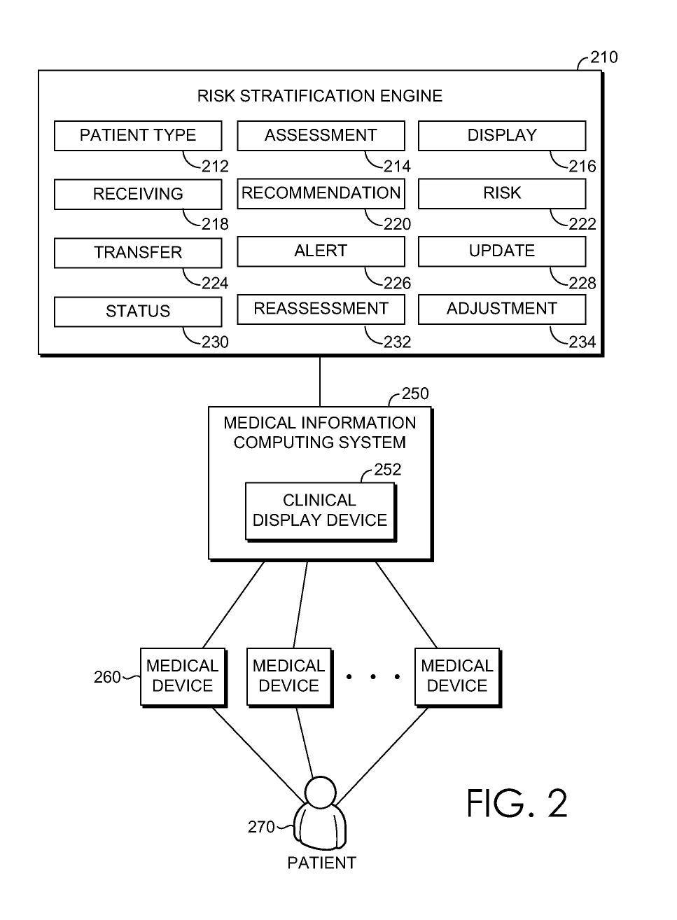

Referring now to FIG. 2, a block diagram is provided illustrating an exemplary system 200 in which a risk stratification engine 210 is shown interfaced with a medical information computing system 250 in accordance with an embodiment of the present invention. The medical information computing system 250 may be a comprehensive computing system within a clinical environment similar to the exemplary computing system 100 discussed above with reference to FIG. 1.

The medical information computing system 250 includes a clinical display device 252. In one embodiment, the clinical display device 252 is configured to display an assessment, recommended pharmacologic and/or mechanical prophylaxis, an overall risk level, alerts, and the like as determined by risk stratification engine 210. In another embodiment, the clinical display device is configured to receive input from the clinician, such as selection of a patient type, information associated with the patient 270, and the like. In another embodiment, the medical information computing system 250 receives input, such as information associated with the patient 270, from one or more medical devices 260.

The risk stratification engine 210 is generally configured to provide dynamic risk stratification clinical decision support to provide clinical advice to clinicians. As shown in FIG. 2, the risk stratification engine 210 includes, may include a patient type component 212, an assessment component 214, a display component 216, a receiving component 218, a recommendation component 220, a risk component 222, and a transfer component 224. In various embodiments, the risk stratification engine 210 may also include an alert component 226, an update component 228, a status component 230, a reassessment component 232, and an adjustment component 234.

Patient type component 212 receives a selection of a patient type for a patient 270. The patient type may indicate, in one embodiment, a particular type or level of care or treatment the patient is receiving. In another embodiment, the patient type may indicate a diagnosis, disease, or condition associated with the patient. In another embodiment, the patient type may indicate a particular unit in a healthcare facility the patient is currently associated with such as an ICU, neurosurgery, cardiac surgery, labor and delivery, antepartum or postpartum, and the like. In one embodiment, patient type may be automatically selected based on a location or proximity associated with the patient. In one embodiment, patient type may be automatically selected based on information from an electronic medical record associated with the patient or information received from medical information computing system 250 or one or more medical devices 260.

Once the patient type is received, assessment component 214 determines an assessment to utilize in accordance with the patient type. In one embodiment, the assessment is determined from one or more assessments associated with various units supported and operated by the healthcare facility. The one or more assessments are, in one embodiment, evidence based risk assessments provided by third parties. In one embodiment, the assessment is a risk stratification assessment for Venous Thromboembolism (VTE). In one embodiment, the VTE assessment is a Padua Prediction Score risk assessment model for medical patients. In one embodiment, the VTE assessment is a Caprini risk assessment model for surgical patients. In one embodiment, the VTE assessment is a pregnancy/postpartum assessment. In one embodiment, the VTE assessment is a Caesarean-section (C-section) risk assessment model. As can be appreciated, the list of available one or more assessments can be customized to fit the needs of the particular healthcare facility and can be updated as necessary based on changes or updates to the risk assessment models.

Once the appropriate assessment is determined by assessment component 214, display component 216 displays the assessment to facilitate a clinician assessing risk factors and contraindications for the patient. In one embodiment, display component guides the clinician through assessing risk factors and contraindications for the patient by providing on screen instructions to aid the clinician in assessing the patient. The risk factors and contraindications associated with the assessment may vary based on the assessment determined by assessment component 214.

Receiving component 218 receives information associated with the patient. The information provides context to the risk stratification by considering relevant allergies, lab results, medications, and other patient information. In one embodiment, the assessment is completed or partially completed with information input by the clinician and received by receiving component 218. In one embodiment, the assessment is completed or partially completed with information received by receiving component 218 from one or more medical devices 260 or the medical information computing system 250. In one embodiment, the assessment is completed or partially completed with information input by the patient and received by receiving component 218. In one embodiment, the assessment is completed or partially completed with information received by receiving component 218 from the patient's electronic medical record. In one embodiment, the assessment is completed with any information received by receiving component 218 from any combination of the embodiments described herein.

Recommendation component 220 recommends pharmacologic prophylaxis, mechanical prophylaxis, or a combination thereof. In embodiments, the prophylaxis is recommended in accordance with current guidelines associated with the assessment (e.g., American College of Chest Physicians (ACCP), National Institute for Health and Clinical Excellence (NICE) guidelines). The prophylaxis is personalized based on the information received by receiving component 218. Because information is received by receiving component 218 from a variety of sources, recommendation component 220 avoids recommending duplicate orders (i.e., items that have already been ordered and are recorded in the patient's electronic medical record) and reminders or alerts that are not necessary.

Risk component 222 indicates an overall risk level associated with the patient. The overall risk level is based on risk factors associated with the assessment and information associated with the patient. In one embodiment, the overall risk level is a combination of major and minor risk scores associated with the assessment.

Transfer component 224 includes the assessment in transfer order sets to facilitate reevaluation of the risk stratification for the patient. For example, it may be necessary to transfer a particular patient from one unit of a healthcare facility to another unit in the same healthcare facility or another healthcare facility altogether. In another example, a patient may have been in surgery and then moved to a post-operative floor. Accordingly, transfer component includes the assessment in post-operative order sets to facilitate reevaluation of the risk stratification for that patient. Including the assessment in the transfer order set enables the receiving unit or healthcare facility to more quickly reevaluate the patient, if necessary.

In one embodiment, alert component 226 alerts the clinician if risk factors for the patient are identified and the assessment has not been completed. In one embodiment, alert component 226 alerts a second clinician (e.g., a nurse). This provides a safety net to patients who have not been fully assessed but information received by receiving component 218 suggests they may have elevated risk.

In one embodiment, update component 228 updates the assessment in accordance with facility protocol or updated guidelines. For example, a particular healthcare facility may have a protocol for a particular type of patient that requires additional assessment. The protocol may further require the assessment to be more strict (i.e., assign a higher risk score based on certain information or provide additional prophylaxis than would otherwise be recommended). Thus, update component 228 allows the healthcare facility to modify the assessment to meet higher standards. Update component 228 also updates the assessment when the guidelines associated with the assessment are updated by the provider of the assessment.

In one embodiment, status component 230 receives an indication of a change in status for the patient. In one embodiment, the change in status reflects a change in patient type. For example, the patient may have initially been assessed as a particular type of patient utilizing one assessment. However, a diagnosis or circumstance may change that indicates the patient should be assessed with a different assessment. In one embodiment, the change in status reflects a change in information associated with the patient. For example, the patient's overall risk factor or recommended prophylaxis may no longer be appropriate due to information indicating the patient's condition has improved, deteriorated, or otherwise changed.

When an indication of a change in status for the patient is received by status component 230, in one embodiment, reassessment component 232 prompts the clinician to perform a reassessment of the patient based on the change in status. Reassessment component 232 further determines if the same assessment should be utilized or if a different assessment should be selected and displayed to clinician by display component 216. As with the original assessment, receiving component 218 receives information associated with the patient. In one embodiment, adjustment component 234 adjusts pharmacologic and/or mechanical prophylaxis in accordance with the reassessment. In addition, adjustment component 234 may adjust the overall risk level associated with the patient based on the reassessment.

Although the risk stratification engine 210 is shown in FIG. 2 as being interfaced with the medical information computing system 250, one skilled in the art will recognize that in embodiments, the risk stratification engine 210 may be integrated into the medical information computing system 250. In other embodiments, the risk stratification engine 210 may simply be interfaced with data stores containing clinical and assessment information independent of a comprehensive medical information computing system 250. However, by interfacing and/or integrating the risk stratification engine 210 with a comprehensive medical information computing system, such as the medical information computing system 250 of FIG. 2, a number of advantages may be realized. For example, the medical information computing system 250 may be interfaced with or otherwise include computing devices and/or computing systems in a variety of different clinical domains within a healthcare environment. By way of example only and not limitation, the medical information computing system 250 may include a clinical laboratory system, a pharmacy system, a radiology system, and a hospital administration system. Accordingly, the medical information computing system 250 provides a unified computing architecture that is able to access and aggregate clinical and assessment information from a variety of different sources and make the clinical and assessment information available to the risk stratification support engine 210. In an embodiment, the medical information computing system 250 may store clinical and assessment information from different sources in a patient-centric electronic medical record.

Another advantage of interfacing and/or integrating the risk stratification engine 210 with the medical information computing system 250 is that risk stratification for clinical decision support may be provided at the point-of-care via a remote computer. For instance, the medical information computing system 250 may include a number of remote computers, such as the remote computers 28 of FIG. 1. The remote computers may be located at, for example, patients' bedsides, nurses' stations, and physicians' offices. Accordingly, clinicians may be able to access the risk stratification engine via a remote computer of the medical information computing system, such that risk stratification for clinical decision support may be provided at the point-of-care.

A further advantage of interfacing and/or integrating the risk stratification engine 210 with the medical information computing system 250 is that information associated with a decision support event may be captured and stored by the medical information computing system 250 with other clinical and assessment information, such as, for instance, in a patient's electronic medical record. For example, information that may be captured from a risk factor event may include clinical information entered by a clinician during the risk factor event, clinical advice determined during the risk factor event, and any orders (i.e., pharmacologic and/or mechanical prophylaxis) entered based on the risk factor event.

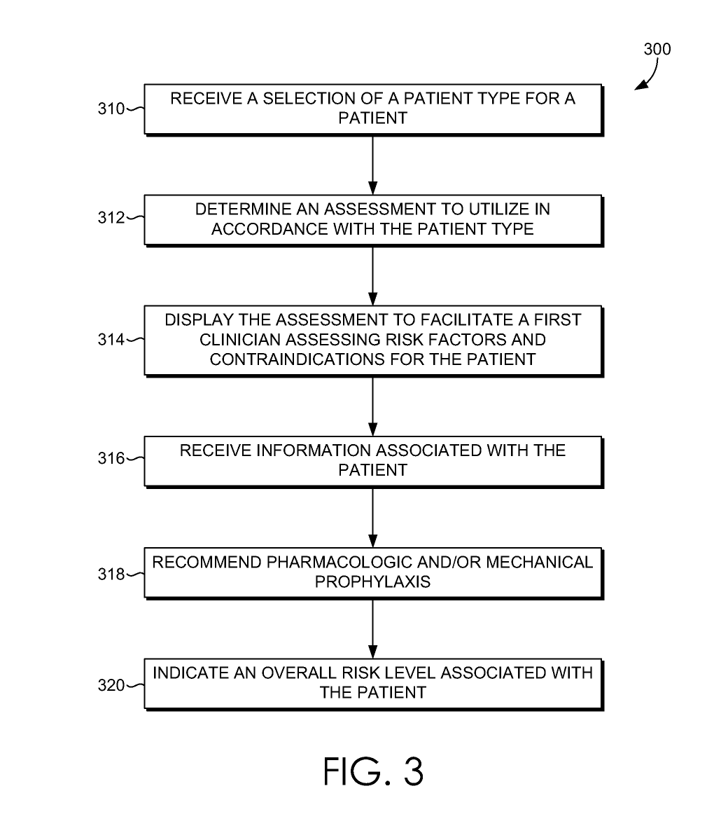

Turning now to FIG. 3, a flow diagram is provided illustrating a method 300 for providing dynamic risk stratification for clinical decision support in accordance with an embodiment of the present invention. Initially, as shown at step 310, a selection of a patient type is received for a patient. The patient type may indicate, in one embodiment, a particular type or level of care or treatment the patient is receiving. In another embodiment, the patient type may indicate a diagnosis, disease, or condition associated with the patient. In another embodiment, the patient type may indicate a particular unit in a healthcare facility the patient is currently associated with such as an ICU, neurosurgery, cardiac surgery, labor and delivery, antepartum or postpartum, and the like. In one embodiment, patient type may be automatically selected based on a location or proximity associated with the patient. In one embodiment, patient type may be automatically selected based on information from an electronic medical record associated with the patient or information received from a medical information computing system or medical devices.

At step 312, an assessment is determined to utilize in accordance with the patient type. In one embodiment, the assessment is determined from one or more assessments associated with various units supported and operated by the healthcare facility. The one or more assessments are, in one embodiment, evidence based risk assessments provided by third parties. In one embodiment, the assessment is a risk stratification assessment for Venous Thromboembolism (VTE). In one embodiment, the VTE assessment is a Padua Prediction Score risk assessment model for medical patients. In one embodiment, the VTE assessment is a Caprini risk assessment model for surgical patients. In one embodiment, the VTE assessment is a pregnancy/postpartum assessment. In one embodiment, the VTE assessment is a Caesarean-section (C-section) risk assessment model. As can be appreciated, the list of available one or more assessments can be customized to fit the needs of the particular healthcare facility and can be updated as necessary based on changes or updates to the risk assessment models.

At step 314, the assessment is displayed to facilitate a first clinician assessing risk factors and contraindications for the patient. In one embodiment, the display guides the clinician through assessing risk factors and contraindications for the patient by providing on screen instructions to aid the clinician in assessing the patient. The risk factors and contraindications associated with the assessment may vary based on the determined assessment.

Information associated with the patient is received, at step 316. The information provides context to the risk stratification by considering relevant allergies, lab results, medications, and other patient information. In one embodiment, the assessment is completed or partially completed with information input by the clinician. In one embodiment, the assessment is completed or partially completed with information received from one or more medical devices or a medical information computing system. In one embodiment, the assessment is completed or partially completed with information input by the patient. In one embodiment, the assessment is completed or partially completed with information received from the patient's electronic medical record. In one embodiment, the assessment is completed with any information received from any combination of the embodiments described herein.

A second clinician is alerted, in one embodiment, if risk factors for the patient are identified and the assessment has not been completed. In one embodiment, the second clinician is the first clinician. This alerting provides a safety net to patients who have not been fully assessed but received information suggests they may have elevated risk.

At step 318, pharmacologic prophylaxis, mechanical prophylaxis, or any combination thereof is recommended. In embodiments, the prophylaxis is recommended in accordance with current guidelines associated with the assessment (e.g., American College of Chest Physicians (ACCP), National Institute for Health and Clinical Excellence (NICE) guidelines). The prophylaxis is personalized based on the received information. Since information is received from a variety of sources, duplicate orders are avoided (i.e., items that have already been ordered and are recorded in the patient's electronic medical record) and reminders or alerts that are not necessary.

An overall risk level associated with the patient is indicated at step 320. The overall risk level is based on risk factors associated with the assessment and information associated with the patient. In one embodiment, the overall risk level is a combination of major and minor risk scores associated with the assessment. In one embodiment, the overall risk level is for VTE.

In one embodiment, the assessment is updated in accordance with facility protocol. For example, a particular healthcare facility may have a protocol for a particular type of patient that requires additional assessment. The protocol may further require the assessment to be more strict (i.e., assign a higher risk score based on certain information or provide additional prophylaxis than would otherwise be recommended). Thus, the healthcare facility can easily modify the assessment to meet higher standards.

In one embodiment, updated guidelines are received for the assessment. For example, the provider of the assessment may periodically review and update its guidelines as necessary. In one embodiment, the assessment is updated in accordance with the updated guidelines.

In one embodiment, an indication of a change in status for the patient is received. In one embodiment, the change in status reflects a change in patient type. For example, the patient may have moved to another unit within a healthcare facility or another healthcare facility altogether. Such a change may impact the patient's overall risk factor or recommended prophylaxis. In one embodiment, the change in status reflects a change in information associated with the patient. For example, the patient's overall risk factor or recommended prophylaxis may no longer be appropriate due to information indicating the patient's condition has improved, deteriorated, or otherwise changed.

In one embodiment, the first clinician is prompted to perform a reassessment of the patient based on the change in status. In one embodiment, it is determined if the same assessment should be utilized or if a different assessment should be selected and displayed to the clinician. As with the original assessment, information associated with the patient is received. In one embodiment, pharmacologic and/or mechanical prophylaxis is adjusted in accordance with the reassessment. In addition, the overall risk level associated with the patient may be adjusted based on the reassessment.

In one embodiment, the assessment is included in transfer order sets to facilitate reevaluation of the risk stratification for the patient. For example, it may be necessary to transfer a particular patient from one unit of a healthcare facility to another unit in the same healthcare facility or another healthcare facility altogether. Including the assessment in the transfer order set enables the receiving unit or healthcare facility to more quickly reevaluate the patient, if necessary.

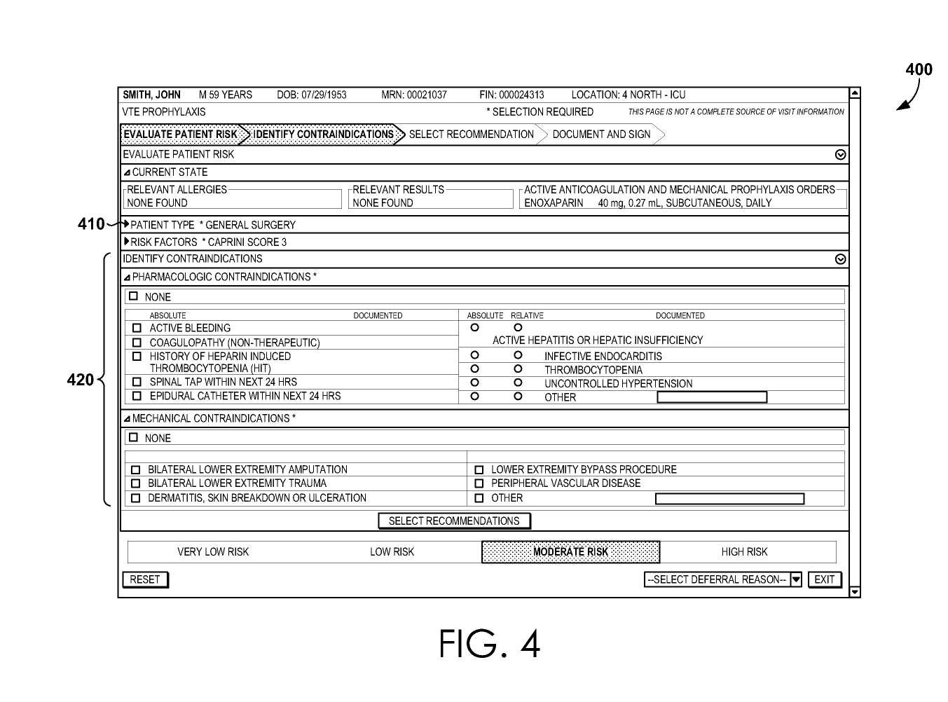

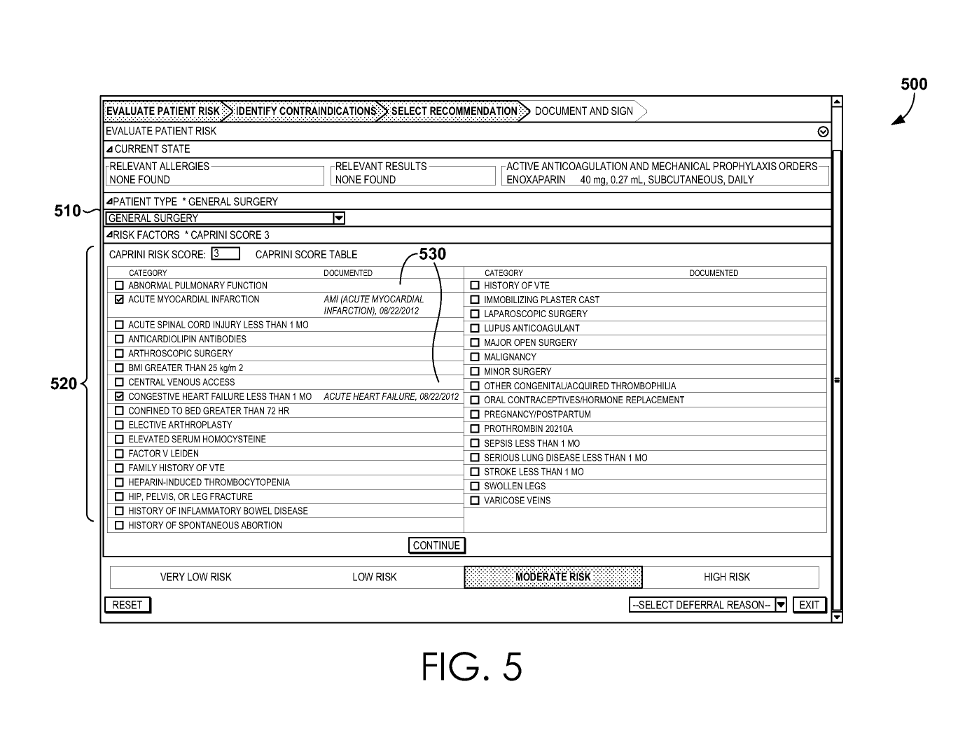

Referring now to FIGS. 4 and 5, illustrative graphical user interfaces 400 and 500 are shown in accordance with embodiments of the present invention. A patient type display area 410, 510 is configured to display a selectable list of patient types for a patient. The patient type may indicate, in one embodiment, a particular type or level of care or treatment the patient is receiving. In another embodiment, the patient type may indicate a diagnosis, disease, or condition associated with the patient. In another embodiment, the patient type may indicate a particular unit in a healthcare facility the patient is currently associated with such as an ICU, neurosurgery, cardiac surgery, labor and delivery, antepartum or postpartum, and the like. In one embodiment, patient type may be automatically selected based on a location or proximity associated with the patient. In one embodiment, patient type may be automatically selected based on information from an electronic medical record associated with the patient or information received from a medical information computing system or medical devices.

An assessment display area 420, 520 is configured to display an assessment to a clinician in accordance with the patient type. In one embodiment, the assessment facilitates the clinician assessing risk factors and contraindications for the patient. In one embodiment, the assessment is determined from one or more assessments associated with various units supported and operated by the healthcare facility. The one or more assessments are, in one embodiment, evidence based risk assessments provided by third parties. In one embodiment, the assessment is a risk stratification assessment for Venous Thromboembolism (VTE). In one embodiment, the VTE assessment is a Padua Prediction Score risk assessment model for medical patients. In one embodiment, the VTE assessment is a Caprini risk assessment model for surgical patients. In one embodiment, the VTE assessment is a pregnancy/postpartum assessment. In one embodiment, the VTE assessment is a Caesarean-section (C-section) risk assessment model. As can be appreciated, the list of available one or more assessments can be customized to fit the needs of the particular healthcare facility and can be updated as necessary based on changes or updates to the risk assessment models.

Information display area 530 is configured to display information associated with the patient. The information provides context to the risk stratification by considering relevant allergies, lab results, medications, and other patient information. In one embodiment, the assessment is completed or partially completed with information input by the clinician. In one embodiment, the assessment is completed or partially completed with information received from one or more medical devices or a medical information computing system. In one embodiment, the assessment is completed or partially completed with information input by the patient. In one embodiment, the assessment is completed or partially completed with information received from the patient's electronic medical record. In one embodiment, the assessment is completed with any information received from any combination of the embodiments described herein.

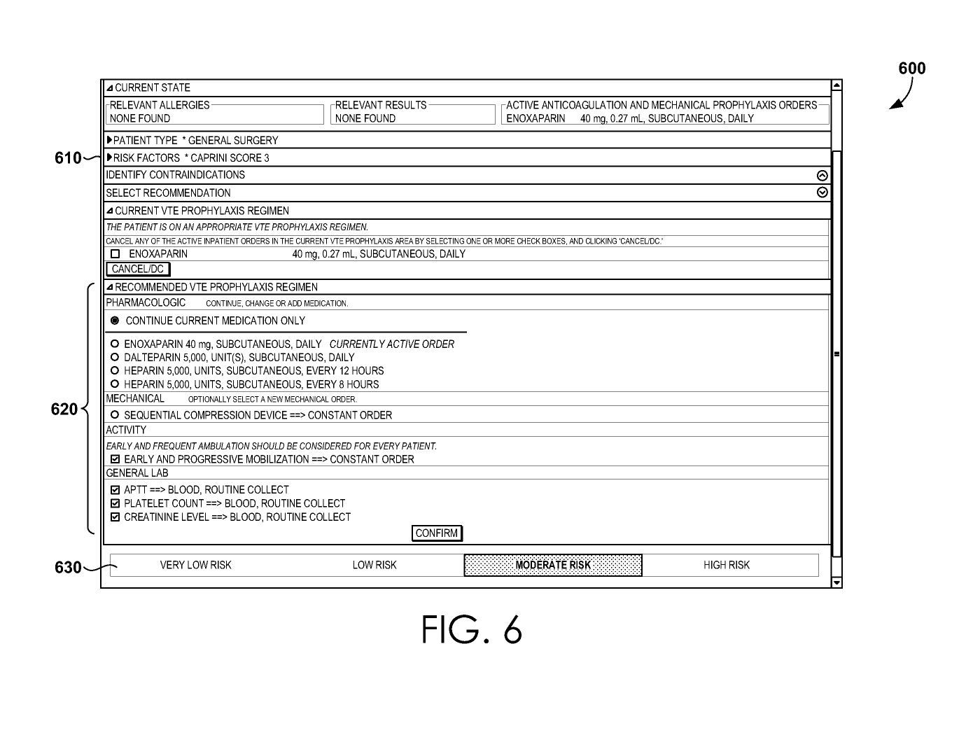

Referring now to FIG. 6, an illustrative graphical user interface 600 is shown in accordance with an embodiment of the present invention. An alert display area 610 is configured to alert the clinician if risk factors for the patient are identified and the assessment has not been completed. In one embodiment, a second clinician is alerted (i.e., a nurse). This alerting provides a safety net to patients who have not been fully assessed but received information suggests they may have elevated risk.

A recommendation display area 620 is configured to display recommendations for pharmacologic prophylaxis, mechanical prophylaxis, or any combination thereof. In embodiments, the prophylaxis is recommended in accordance with current guidelines associated with the assessment (e.g., American College of Chest Physicians (ACCP), National Institute for Health and Clinical Excellence (NICE) guidelines). The prophylaxis is personalized based on the received information. Since information is received from a variety of sources, duplicate orders are avoided (i.e., items that have already been ordered and are recorded in the patient's electronic medical record) and reminders or alerts that are not necessary.

A risk display area 630 is configured to display an overall risk level associated with the patient. The overall risk level is based on risk factors associated with the assessment and information associated with the patient. In one embodiment, the overall risk level is one of very low risk, low risk, moderate risk, and high risk. In one embodiment, the overall risk level is a combination of major and minor risk scores associated with the assessment. In one embodiment, the overall risk level is for VTE.

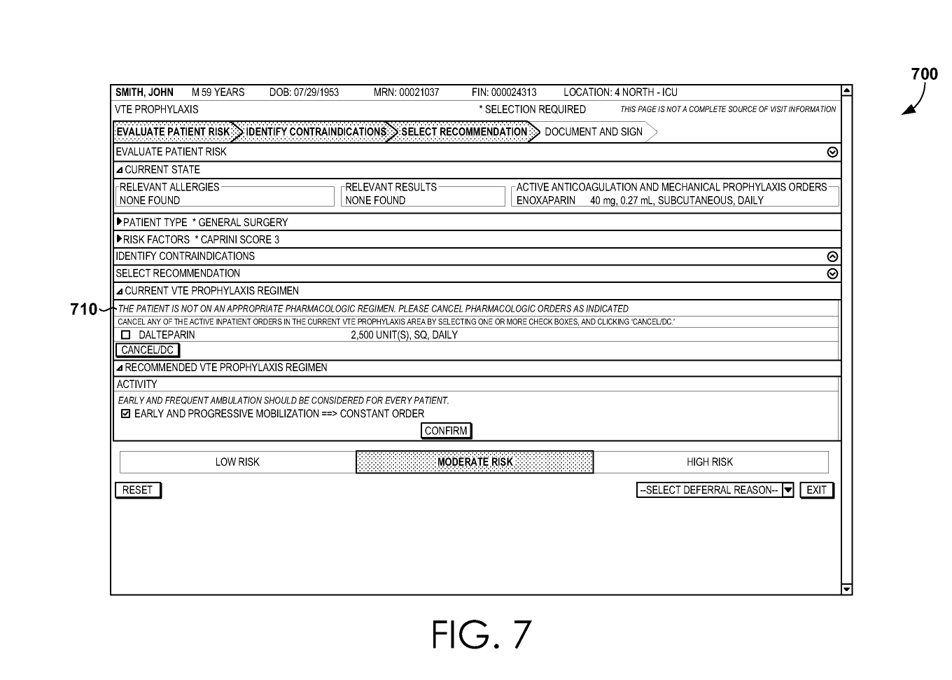

Referring now to FIG. 7, an illustrative graphical user interface 700 is shown in accordance with an embodiment of the present invention. A warning display area 710 is configured to prompt the clinician if the patient is not on an appropriate prophylaxis regimen. This may indicate a change in status for the patient. In one embodiment, the change in status reflects a change in patient type. For example, the patient may have moved to another unit within a healthcare facility or another healthcare facility altogether. Such a change may impact the patient's overall risk factor or recommended prophylaxis. In one embodiment, the change in status reflects a change in information associated with the patient. For example, the patient's overall risk factor or recommended prophylaxis may no longer be appropriate due to information indicating the patient's condition has improved, deteriorated, or otherwise changed.

As can be understood, the present invention provides systems, methods, and user interfaces for providing dynamic risk stratification for clinical decision support. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. Computer storage media having computer-executable instructions embodied thereon that, when executed by one or more computing devices, cause the one or more computing devices to perform a method of providing dynamic risk stratification for clinical decision support, the method comprising:
receiving a selection of a patient type for a patient;
determining an assessment to utilize in accordance with the patient type;
displaying the assessment to facilitate a first clinician assessing risk factors and contraindications for the patient;
receiving information associated with the patient;
recommending pharmacologic prophylaxis, mechanical prophylaxis, or a combination thereof; and
indicating an overall risk level associated with the patient.

2. The media of claim 1, wherein the assessment is a risk stratification assessment for Venous Thromboembolism (VTE).

3. The media of claim 1, further comprising alerting a second clinician if risk factors for the patient are identified and the assessment has not been completed.

4. The media of claim 2, wherein the VTE assessment is one of Padua Prediction Score risk assessment model for medical patients, Caprini risk assessment model for surgical patients, or pregnancy/postpartum or Caesarean-section risk scoring models.

5. The media of claim 1, further comprising updating the assessment in accordance with facility protocol.

6. The media of claim 1, further comprising receiving updated guidelines for the assessment.

7. The media of claim 6, further comprising updating the assessment in accordance with the updated guidelines.

8. The media of claim 1, further comprising receiving an indication of a change in status for the patient.

9. The media of claim 8, further comprising prompting the first clinician to perform a reassessment of the patient based on the change in status.

10. The media of claim 9, further comprising adjusting pharmacologic and/or mechanical prophylaxis in accordance with the reassessment.

11. The media of claim 1, further comprising including the assessment in transfer order sets to facilitate reevaluation of the risk stratification for the patient.

12. A computer system for providing dynamic risk stratification for clinical decision support, the computer system comprising a processor coupled to a computer storage medium, the computer storage medium having stored thereon a plurality of computer software components executable by the processor, the computer software components comprising:
a patient type component for receiving a selection of a patient type for a patient;
an assessment component for determining an assessment to utilize in accordance with the patient type;
a display component for displaying the assessment to facilitate a clinician assessing risk factors and contraindications for the patient;
a receiving component for receiving information associated with the patient;
a recommendation component for recommending pharmacologic prophylaxis, mechanical prophylaxis, or a combination thereof;
a risk component for indicating an overall risk level associated with the patient; and
a transfer component for including the assessment in transfer order sets to facilitate reevaluation of the risk stratification for the patient.

13. The system of claim 12, further comprising an alert component for alerting the clinician if risk factors for the patient are identified and the assessment has not been completed.

14. The system of claim 12, further comprising an update component for updating the assessment in accordance with facility protocol or updated guidelines.

15. The system of claim 12, further comprising a status component for receiving an indication of a change in status for the patient.

16. The system of claim 15, further comprising a reassessment component for prompting the clinician to perform a reassessment of the patient based on the change in status.

17. The system of claim 16, further comprising an adjustment component for adjusting pharmacologic and/or mechanical prophylaxis in accordance with the reassessment.

18. Computer storage media having computer-executable instructions embodied thereon that, when executed, produce a graphical user interface (GUI) to facilitate providing dynamic risk stratification for clinical decision support, the GUI comprising:
a patient type display area configured to display a selectable list of patient types for a patient;
an assessment display area configured to display an assessment to a clinician in accordance with the patient type;
an information display area configured to display information associated with the patient;
an alert display area configured to alert the clinician if risk factors for the patient are identified and the assessment has not been completed;
a recommendation display area configured to display recommendations for pharmacologic prophylaxis, mechanical prophylaxis, or a combination thereof; and
a risk display area configured to display an overall risk level associated with the patient.

19. The GUI of claim 18, wherein the assessment facilitates the clinician assessing risk factors and contraindications for the patient.

20. The GUI of claim 18, further comprising a warning display area configured to prompt the clinician if the patient is not on an appropriate prophylaxis regimen.
